(19) United States
(12) Patent Application Publication
(10) Pub. No.: US 2005/0264173 A1
(43) Pub. Date: Dec. 1, 2005

(54) White light emitting diode light source and method for manufacturing the same

(75) Inventors: Bily Wang, Hsin Chu City (TW); Jonnie Chuang, Pan Chiao City (TW); Chuanfa Lin, Shu Lin City (TW)

Correspondence Address: TROXELL LAW OFFICE PLLC, SUITE 1404, 5205 LEESBURG PIKE, FALLS CHURCH, VA, 22041, US

(73) Assignee: HARVATEK CORPORATION

(21) Appl. No.: 10/855,419

(22) Filed: May 28, 2004

(51) Int. Cl. H05B 33/00

(52) U.S. Cl. 313/500; 313/484; 313/485; 313/486

(57) ABSTRACT

A while light emitting diode light source and method for manufacturing the same are proposed. The while light emitting diode light source has a printed circuit board, and a plurality of LED units on one face of the PCB, each of the LED units comprising a substrate, a blue LED on the substrate and a red-green-yellow phosphor mixture enclosing the blue LED. The red-green-yellow phosphor mixture is a mixture of a red phosphor, a green phosphor and a yellow phosphor. The red phosphor is CaS:Eu or SrS:Eu. The green phosphor is SrGa₂S₄:Eu or Ca₈EuMnMg(SiO₄)₄C₁₂. The yellow phosphor is YAG:Ce or ThAG:Ce. The light emitted from the phosphors are mixed with blue light into white light with a satisfactory color rendering property.

### FIELD OF THE INVENTION

The present invention relates to a white light emitting diode light source and a method for manufacturing the same, and especially to a white light emitting diode light source with a satisfactory color rendering property and high lighting efficiency, and a method for manufacturing the same.

### BACKGROUND OF THE INVENTION

Compact white light sources are extensively used for backlight modules of scanners or color panel displays. Therefore, the improvement of white light sources is also great issue for the related industries.

FIG. 1 shows an exploded view of an edge backlight module 10, which comprises a panel light guide 100, a lamp 102 on one side of the panel light guide 100, a lamp reflecting plate 104 on outer side of the lamp 102, and a reflecting plate 106 on bottom of the panel light guide 100. The edge backlight module 10 further comprises prism and light diffusing plates (not shown). The edge backlight module 10 can be used for a panel display and the lamp 102 can be a CCFL for emitting white light. The light emitted from the lamp 102 is reflected by the lamp reflecting plate 104 and then guided by the panel light guide 100, the prism and the light diffusing plate for forward emission. The forward emission can provide backlight for an LCD device.

However, the CCFL has the following problems: (1) complicated circuit design due to a high driving voltage; (2) unstable illumination that varies with the temperature; and (3) a dead zone present at both end of the lamp. When the edge backlight module 10 is used for a scanner, the scanning quality is degraded due to the suboptimal conditions mentioned above.

The rapid progress in LED technologies increases the possibility of replacing the CCFL with an LED, and the white LED can be provided by in the following two ways:

(1) When a blue LED is used with yellow phosphor, the illumination efficiency thereof is influenced by the phosphor.

(2) When red, green and blue LEDs are used together to mix a white light, the color temperature of this white LED may be unstable due to process variation of the LEDS.

### SUMMARY OF THE INVENTION

It is an object of the present invention to provide a white light emitting diode light source with a satisfactory color rendering property and high lighting efficiency and a method for manufacturing the same.

To achieve this object, the present invention provides a while light emitting diode light source. The while light emitting diode light source includes a printed circuit board, and a plurality of LED units on one face of the PCB, each of the LED units comprising a substrate, a blue LED on the substrate and a red-green-yellow phosphor mixture enclosing the blue LED. The red-green-yellow phosphor mixture is a mixture of a red phosphor, a green phosphor and a yellow phosphor. The red phosphor is CaS:Eu or SrS:Eu. The green phosphor is SrGa₂S₄:Eu or Ca₈EuMnMg(SiO₄)₄C₁₂. The yellow phosphor is YAG:Ce or ThAG:Ce. The light emitted from the phosphors are mixed with blue light into white light with a satisfactory color rendering property.

The above summaries are intended to illustrate exemplary embodiments of the invention, which will be best understood in conjunction with the detailed description to follow, and are not intended to limit the scope of the appended claims.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings, in which:

FIG. 1 shows an exploded view of a conventional edge backlight module;

FIGS. 2A and 2B are schematic views of a white light emitting diode light source according to the present invention;

FIG. 3 shows a top view of an LED unit;

FIG. 4 shows the emission spectrum of the LED unit; and

FIG. 5 shows a flowchart of manufacturing method for the white light emitting diode light source according to the present invention.

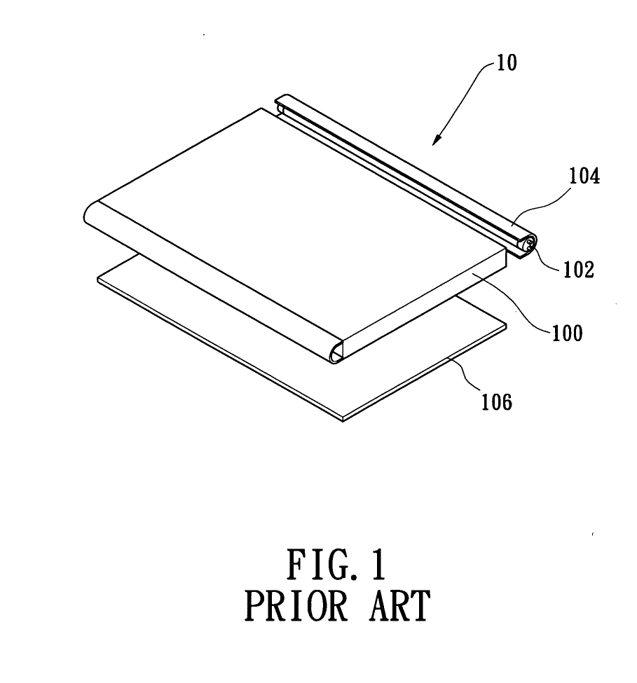

### DETAILED DESCRIPTION OF THE INVENTION

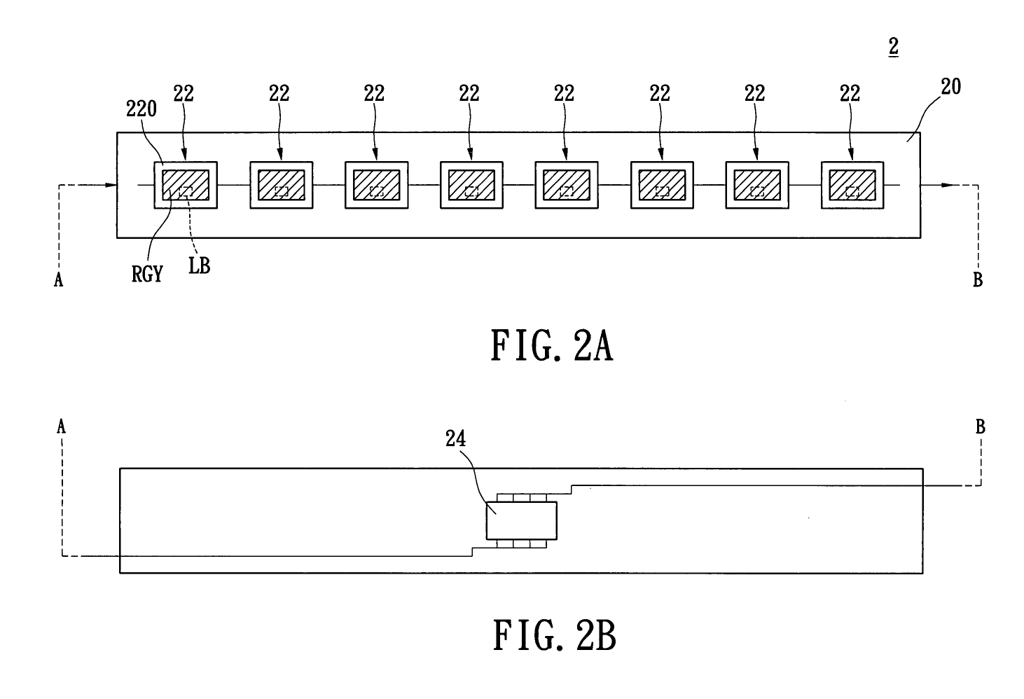

FIGS. 2A and 2B are schematic views of a white light emitting diode light source 2 according to the present invention. The light emitting diode light source 2 comprises a PCB 20, a plurality of LED units 22 on one face of the PCB 20 and a controller on another face of the PCB 20.

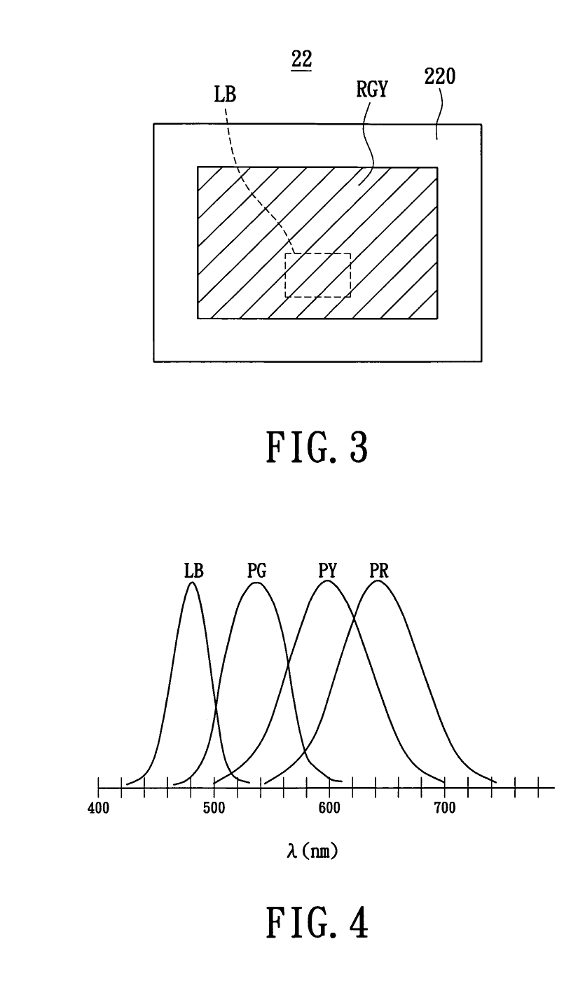

FIG. 3 shows a top view of an LED unit 22, which comprises a substrate 220 such as an insulating material, a blue LED LB (manufactured from, for example, nitride compound material and with an emission wavelength of 400-490 nm) on the substrate 220 and a red-green-yellow phosphor mixture RGY on the blue LED LB. The red-green-yellow phosphor mixture RGY is a mixture of a red phosphor PR, a green phosphor PG and a yellow phosphor PY.

The LED unit 22 has conductive wire (not shown) connecting the anode and cathode of the blue LED LB to pads (not shown) on the substrate 220 for supplying electrical power to the blue LED LB. The connection of conductive wire to an LED is a well known art and is not stated in detail here. In the demonstrated embodiment, the blue LED LB is in a surface mount package. It should be noted the blue LED LB can be other package types such as lamp-type or chip on board (COB)-type.

The blue LED LB emits blue light after being driven by suitable electrical current. The red phosphor PR, the green phosphor PG and the yellow phosphor PY will emit red light, green light and yellow light, respectively, after absorbing the blue light.

FIG. 4 shows the emission spectrum of the LED unit 22, in which the curves are, from left to right, a blue LED LB emission spectrum, a green phosphor PG emission spectrum, a yellow phosphor PY emission spectrum and a red phosphor PR emission spectrum. In comparison with the prior art white light source, the white light emitting diode light source according to the present invention has a better color rendering property because the white light emitting diode light source has a broader spectrum.

More particularly, the prior art white light source has a poor color rendering property because it only has a blue LED and yellow phosphor. The white light emitting diode light source according to the present invention has a better color rendering property because it also covers the red and green spectra. The color temperature of the white light emitting diode light source according to the present invention can be flexibly adjusted by changing the mixed ratio of the red phosphor PR, the green phosphor PG and the yellow phosphor PY.

In the present invention, the red phosphor PR can be, but is not limited to, CaS:Eu or SrS:Eu; the yellow phosphor PY can be, but is not limited to, YAG:Ce or ThAG:Ce; and the green phosphor PG can be, but is not limited to, SrGa₂S₄:Eu or Ca₈EuMnMg(SiO₄)₄C₁₂. It should be noted the present invention can use other phosphor material excitable by blue light with a wavelength of 400-490 nm.

Moreover, in above preferred embodiment, the red-green-yellow phosphor mixture RGY can be replace by a mixture of red phosphor PR and the green phosphor PG to provide a white light of satisfactory color temperature.

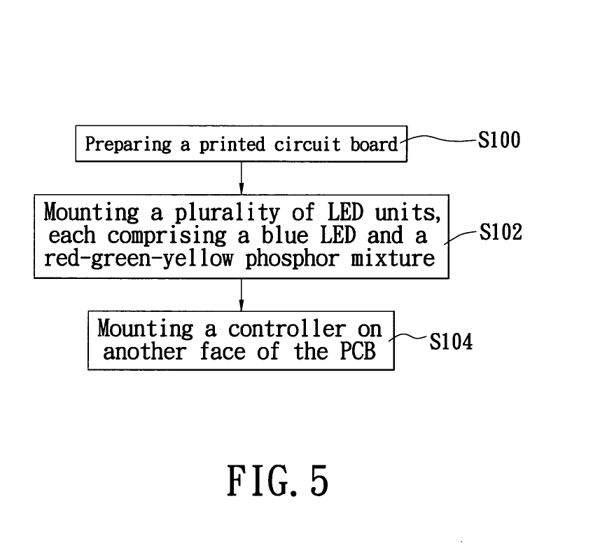

FIG. 5 shows a flowchart of the manufacturing method for the white light emitting diode light source according to the present invention. The method comprises the following steps:

S100: Preparing a printed circuit board (PCB).

S102: Mounting a plurality of LED units on one face of the PCB. Each of the LED units comprises a substrate, a blue LED on the substrate and a red-green-yellow phosphor mixture on the blue LED. The red-green-yellow phosphor mixture is a mixture of a red phosphor, a green phosphor and a yellow phosphor and encloses the blue LED.

S104: Mounting a controller on another face of the PCB.

To sum up, the white light emitting diode light source of the present invention has a satisfactory color rendering property and a high lighting efficiency.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A while light emitting diode light source, comprising:
a printed circuit board (PCB); and
a plurality of LED units on one face of the PCB, each of the LED units comprising a substrate, a blue LED on the substrate and a red-green-yellow phosphor mixture enclosing the blue LED, wherein the red-green-yellow phosphor mixture is a mixture of a red phosphor, a green phosphor and a yellow phosphor.

2. The while light emitting diode light source as in claim 1, further comprising a controller on another face of the PCB.

3. The while light emitting diode light source as in claim 1, wherein the red phosphor is CaS:Eu, SrS:Eu or a mixture thereof.

4. The while light emitting diode light source as in claim 1, wherein the green phosphor is SrGa₂S₄:Eu, Ca₈EuMnMg(SiO₄)₄C₁₂ or a mixture thereof.

5. The while light emitting diode light source as in claim 1, wherein the yellow phosphor is YAG:Ce, ThAG:Ce or a mixture thereof.

6. The while light emitting diode light source as in claim 1, wherein the LED units are in a surface mount package.

7. The while light emitting diode light source as in claim 1, wherein the LED units are in a lamp-type package.

8. The while light emitting diode light source as in claim 1, wherein the LED units are in chip on board (COB) package.

9. The while light emitting diode light source as in claim 1, wherein the substrate is an insulating material.

10. The while light emitting diode light source as in claim 1, wherein the LED unit is made of a nitride compound.

11. The while light emitting diode light source as in claim 1, wherein the LED unit emits light with a wavelength of about 400-490 nm.

12. The while light emitting diode light source as in claim 1, wherein the red phosphor, the green phosphor and the yellow phosphor are mixed in a predetermined ratio to produce a white light of a predetermined color temperature.

13. The while light emitting diode light source as in claim 2, wherein the controller provides a predetermined driving current to the LED unit to produce a white light of a predetermined color temperature.

14. A while light emitting diode light source, comprising:
a printed circuit board (PCB); and
a plurality of LED units on one face of the PCB, each of the LED units comprising a substrate, a blue LED on the substrate and a red-green phosphor mixture enclosing the blue LED, wherein the red-green phosphor mixture is a mixture of a red phosphor and a green phosphor.

15. The while light emitting diode light source as in claim 14, further comprising a controller on another face of the PCB.

16. The while light emitting diode light source as in claim 14, wherein the red phosphor is CaS:Eu, SrS:Eu or a mixture thereof.

17. The while light emitting diode light source as in claim 14, wherein the green phosphor is SrGa₂S₄:Eu, Ca₈EuMnMg(SiO₄)₄C₁₂ or a mixture thereof.

18. The while light emitting diode light source as in claim 14, wherein the LED unit emits light with a wavelength of about 400-490 nm.

19. A method for manufacturing while light emitting diode light source, comprising steps of:
providing a printed circuit board (PCB); and
providing a plurality of LED units on one face of the PCB, each of the LED units comprising a substrate, a blue LED on the substrate and a red-green-yellow phosphor mixture enclosing the blue LED, wherein the red-green-yellow phosphor mixture is a mixture of a red phosphor, a green phosphor and a yellow phosphor.

20. The method as claim 19, further comprising a step of:
providing a controller on another face of the PCB.

21. The method as in claim 19, wherein the red phosphor is CaS:Eu, SrS:Eu or a mixture thereof.

22. The method as in claim 19, wherein the green phosphor is SrG a₂S₄:Eu, Ca₈EuMnMg(SiO₄)₄C₁₂ or a mixture thereof.

23. The method as in claim 19, wherein the yellow phosphor is YAG:Ce, ThAG:Ce or a mixture thereof.

24. The method as in claim 19, wherein the LED units are in a surface mount package.

25. The method as in claim 19, wherein the LED units are in a lamp-type package.

26. The method as in claim 19, wherein the LED units are in a chip on board (COB) package.

27. The method as in claim 19, wherein the substrate is an insulating material.

28. The method as in claim 19, wherein the LED unit is made of a nitride compound.

29. The method as in claim 19, wherein the LED unit emits light with a wavelength of about 400-490 nm.
